(19) United States
(12) Patent Application Publication
(10) Pub. No.: US 2018/0335879 A1
(43) Pub. Date: Nov. 22, 2018

(54) IN-CELL TOUCH AND DISPLAY APPARATUS, COMMON VOLTAGE PROVIDER, AND PROVIDING METHOD THEREOF

(71) Applicant: HIMAX TECHNOLOGIES LIMITED, Tainan City (TW)

(72) Inventors: Wei-Song Wang, Tainan City (TW); Yaw-Guang Chang, Tainan City (TW)

(73) Assignee: HIMAX TECHNOLOGIES LIMITED, Tainan City (TW)

(21) Appl. No.: 15/598,010

(22) Filed: May 17, 2017

(51) Int. Cl. G06F 3/041; G09G 3/20

(52) U.S. Cl. CPC G06F 3/0412; G09G 3/2092

(57) ABSTRACT

The common voltage provider includes a channel selector and a voltage generator. The channel selector is coupled to an in-cell touch and display panel, for selecting to connect a plurality of first common voltage blocks to a first channel, and connect a plurality of second common voltage blocks to at least one second channel according to a plurality gate line signals wherein the first common voltage blocks upon a scanned gate line and the second common voltage blocks upon a plurality of non-scanned gate lines, and the gate line signals are respectively received by the scanned gate line and the non-scanned gate lines. The voltage generator is coupled to the first channel and the at least one second channel, and providing a first common voltage to the first channel.

### BACKGROUND

### Field of the Invention

The invention is directed to an in-cell touch and display apparatus and more particularly, to a common voltage provider and a providing method for the in-cell touch and display apparatus.

### Description of Related Art

Referring to FIG. 1, which illustrates a schematic diagram of a common voltage provider in conventional art. In the conventional art, a common voltage providing buffer BUF1 is provided to supply a common voltage VCOM1 to all of common voltage blocks of an in-cell touch and display panel. The common voltage providing buffer BUF1 receives an input voltage VIN and generates the common voltage VCOM1 to the voltage blocks through route which has resistance Rr, where the parasitic capacitor C1 is generated between a source line and the corresponding common voltage block. When the in-cell touch and display panel is operated, the parasitic capacitor C1 also receives a source signal SS transited periodically from the source line, a voltage level of the common voltage VCOM1 is varied by coupling the source signal SS. During a scan period, if the voltage level of the common voltage VCOM1 can't recover to a target voltage, and display quality is reduced accordingly.

### SUMMARY

The invention provides an in-cell touch and display apparatus, a common voltage provider, and a providing method thereof for reducing a stable time of the common voltage blocks, which are upon a scanned gate line, to a target voltage.

The invention is directed to the common voltage provider including a channel selector and a voltage generator. The channel selector is coupled to an in-cell touch and display panel, for selecting to connect a plurality of first common voltage blocks to a first channel, and connect a plurality of second common voltage blocks to at least one second channel according to a plurality gate line signals, wherein the first common voltage blocks are upon a scanned gate line and the second common voltage blocks are upon a plurality of non-scanned gate lines, and the gate line signals are respectively received by the scanned gate line and the non-scanned gate lines. The voltage generator is coupled to the first channel and the at least one second channel, and providing a first common voltage to the first channel.

The invention is also directed to the in-cell touch and display apparatus including a panel and the common voltage provider. The panel has a plurality common voltage blocks arranged in an array, and is coupled to the common voltage provider.

The invention is further directed to the common voltage providing method including: selecting to connect a plurality of first common voltage blocks to a first channel, and connect a plurality of second common voltage blocks to at least one second channel according to a plurality gate line signals by a channel selector; and, providing a first common voltage to the first channel. Wherein, the first common voltage blocks are coupled to a scanned gate line and the second common voltage blocks are coupled to a plurality of non-scanned gate lines, and the gate line signals are respectively received by the scanned gate line and the non-scanned gate lines.

To sum up, the invention provides the channel selector to connect the first common voltage blocks which are coupled to the scanned gate line to a first channel and connect the second common voltage blocks which are not coupled the scanned gate line to a second channel. The invention further provides voltage generator to respectively provide common voltages to the first and second channel. That is, a parasitical capacitance on the first channel can be reduced, and a voltage level of the common voltage provided to the first common voltage blocks can be stabled.

In order to make the aforementioned and other features and advantages of the invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 illustrates a schematic diagram of a common voltage provider in conventional art.

FIG. 2 illustrates a schematic diagram of an in-cell touch and display apparatus according to an embodiment of present disclosure.

FIG. 3 illustrates a schematic diagram of another in-cell touch and display apparatus according to another embodiment of present disclosure.

FIG. 4 illustrates a schematic plot of a circuit behavior of the in-cell touch and display apparatus according to an embodiment of present disclosure.

FIG. 5 illustrates another schematic diagram of the in-cell touch and display apparatus according to the embodiment in FIG. 3.

FIG. 6A to FIG. 6E respectively illustrate schematic plots of a plurality of voltage generator according to an embodiment of present disclosure.

FIG. 7 illustrates a flow chart of a common voltage providing method according to an embodiment of present disclosure.

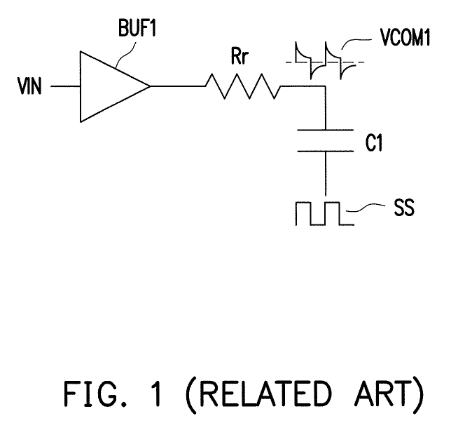

### DESCRIPTION OF EMBODIMENTS

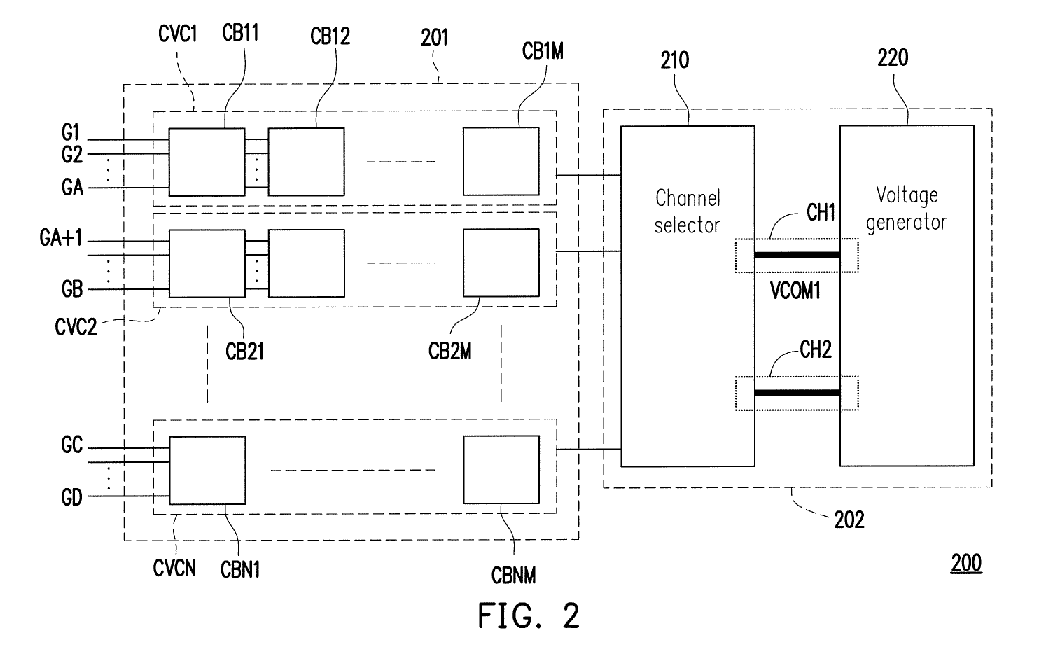

Please refer to FIG. 2, which illustrates a schematic diagram of an in-cell touch and display apparatus according to an embodiment of present disclosure. The in-cell touch and display apparatus 200 includes a panel 201 and a common voltage provider 202. The panel 201 is coupled to the common voltage provider 202. The panel 201 may be an in-cell touch and display panel and includes a plurality of common voltage blocks CB11-CBNM, where the common voltage blocks CB11-CBNM are arranged in an array. In FIG. 2, the common voltage blocks CB11-CBNM form a plurality of common voltage block rows CVC1-CVCN. Furthermore, the panel 201 further receives a plurality of gate line signals G1-GD, and the gate line signals G1-GD may form a plurality of gate line signal groups and the gate line signal groups are respectively transported to the common voltage block rows CVC1-CVCN. For example, the common voltage block row CVC1 is upon and coupled with a plurality of gate lines for receiving the gate line signal group with gate line signals G1-GA, and the common voltage block row CVC2 is upon and coupled with a plurality of gate lines for receiving the gate line signal group with gate line signals GA+1-GB. In FIG. 2, pixels corresponding to each of the common voltage blocks CB11-CBNM receive same common voltage.

The common voltage provider 202 includes a channel selector 210 and a voltage generator 220. The channel selector 210 is coupled to the panel 201. The channel selector 210 selects first common voltage blocks among the common voltage blocks CB11-CBNM to connect to a first channel CH1, and selects second common voltage blocks among the common voltage blocks CB11-CBNM to connect to a second channel CH2. The voltage generator 220 is coupled to the channel selector 210 through the first channel CH1 and the second channel CH2. The voltage generator 220 provides a common voltage VCOM1 to the first channel CH1, and the voltage generator 220 may provide another common voltage VCOM2 to the second channel CH2 or set the second channel CH2 to be floated.

Please be noted here, the common voltage blocks CB11-CBNM which are the first common voltage blocks or the second common voltage blocks are determined according to the gate line signals G1-GD. If one of the gate line signals G1-GD is enabled for scanning operation, the common voltage blocks upon the scanned gate line receiving the enabled gate line signal are the first common voltage blocks, and the common voltage blocks upon the non-scanned gate lines without receiving the enabled gate line signals are the second common voltage blocks. For example, if one of the gate line signals G1-GA is enable for scanning operation the common voltage blocks CB11-CB1M are first common voltage blocks and the other voltage blocks CB21-CBNM are second common voltage blocks. Herein, the common voltage block row CVC1 may be a first common voltage block row, and the common voltage block rows CVC2-CVCN may be second common voltage block rows.

That is, if the common voltage block row CVC1 is the first common voltage block row, the common voltage block row CVC1 is coupled to the first channel CH1 through the channel selector 210. The voltage generator 220 provides the common voltage VCOM1 to the common voltage block row CVC1 through the channel selector 210. At the same time, the channel selector 210 coupled the common voltage block rows CVC2-CVCN which are the second common voltage block rows to the second channel CH2, and the common voltage block rows CVC2-CVCN may receive another common voltage or be floated through the second channel CH2.

Please be noted here, number of the second common voltage block rows is larger than number of the first common voltage block row, and a capacitance on the first common voltage blocks coupled to the first channel CH1 is smaller than a capacitance on the second common voltage blocks coupled to the second channel CH2. Therefore, a voltage level of the common voltage VCOM1 provided to the common voltage block row CVC1 (the first common voltage block row) can recover to a stable voltage level quickly, and display performance corresponding to the common voltage block row CVC1 can be kept well.

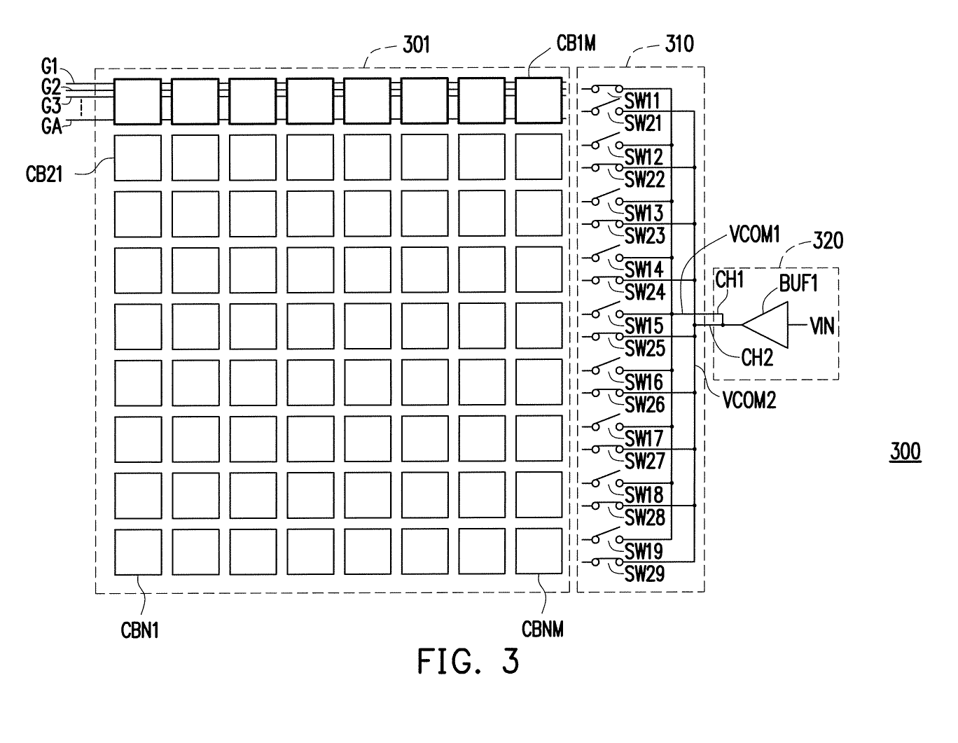

Referring to FIG. 3, which illustrates a schematic diagram of another in-cell touch and display apparatus according to another embodiment of present disclosure. The in-cell touch and display apparatus 300 includes a panel 301 and a common voltage provider formed by a channel selector 310 and a voltage generator 320. In this embodiment, the channel selector 310 includes a plurality of switches SW11-SW19 and SW21-SW29, where the switches SW11-SW19 are commonly coupled to a first channel CH1, and the switches SW21-SW29 are commonly coupled to a second channel CH2. Further, one of the switches SW11-SW19 (ex. the switch SW11) and neighbored switch (ex. the switch SW21) form a switch pair, and the switch pair is coupled to a same common voltage block row formed by the common voltage blocks CB11-CB1M. The common voltage blocks CB11-CB1M are upon the gate lines receiving the gate line signals G1-GA, and if at least one of the gate line signals G1-GA is enabled for scanning operation, the common voltage block row formed by the common voltage blocks CB11-CB1M is the first common voltage block row. At this time, the switch SW11 is turned on and the switch SW21 is cut off, and the common voltage blocks CB11-CB1M are coupled to the first channel CH1 through the channel selector 310.

On the other hand, if the common voltage block row formed by the common voltage blocks CB11-CB1M is the first common voltage block row, the other common voltage block rows formed by the common voltage blocks CB21-CBNM are the second common voltage blocks. The common voltage block rows formed by the common voltage blocks CB21-CBNM are coupled to the second channel CH2 through the turned-on switches SW22-SW29, where the switches SW12-SW19 are cut off.

The voltage generator 320 includes a common voltage generating buffer BUF1, and the common voltage generating buffer BUF1 receives an input voltage and is coupled to the first channel CH1 and the second channel CH2 by an output end. The first channel CH1 and the second channel CH2 are respectively formed by two different wires coupled to the output end of the common voltage generating buffer BUF1, and the common voltage generating buffer BUF can provides a common voltage VCOM1 to the first channel CH1 and provides a common voltage VCOM2 to the second channel CH2.

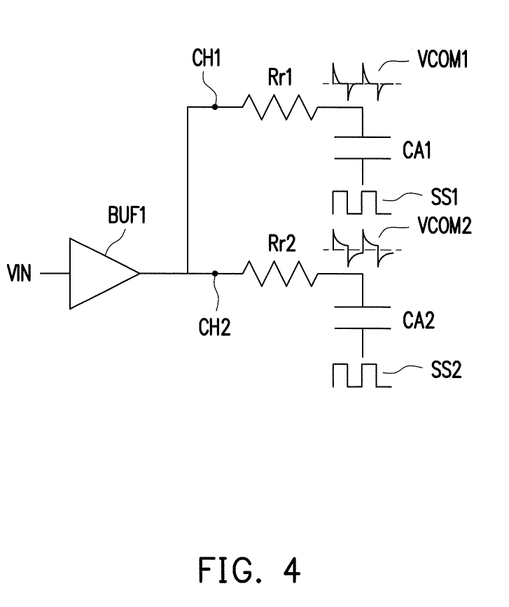

Referring to FIG. 4, which illustrates a schematic plot of a circuit behavior of the in-cell touch and display apparatus according to an embodiment of present disclosure. In FIG. 4, the common voltage generating buffer BUF1 provides the common voltage VCOM1 through the first channel CH1 and a route resistor Rr1 to the first common voltage block row, and provides the common voltage VCOM2 through the second channel CH2 and a route resistor Rr2 to the second common voltage block rows. The first common voltage block row has a parasitical capacitor CA1 and the second common voltage block rows have a parasitical capacitor CA2, where a capacitance of the parasitical capacitor CA1 is smaller than a capacitance of the parasitical capacitor CA2. That is, a voltage level of the common voltages VCOM1 and VCOM2 may be respectively effected by a source signal SS1 and a source signal SS2, and the voltage level of the common voltage VCOM1 can recover to a stable level more quickly than the recovering of the voltage level of the common voltage VCOM2, and the display performance corresponding to the first common voltage block row can be kept well.

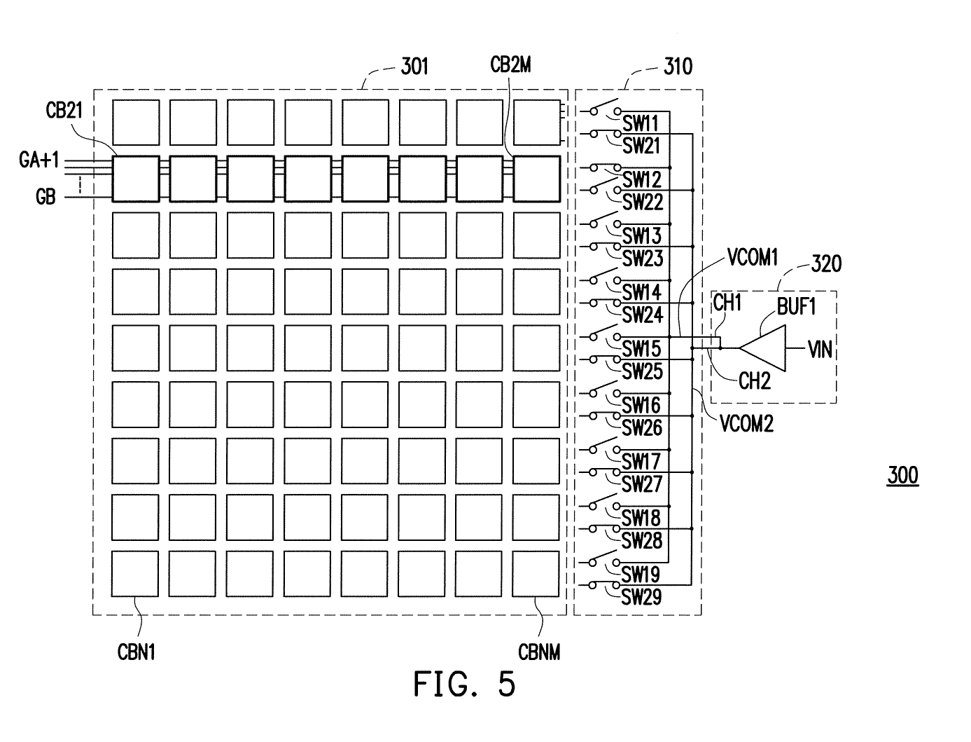

Referring to FIG. 5, which illustrates another schematic diagram of the in-cell touch and display apparatus according to the embodiment in FIG. 3. Furthermore, enable statuses of the gate line signals on the in-cell touch and display apparatus 300 can be varied according to a display scanning operation of the in-cell touch and display apparatus 300. If at least one of the gate line signals GA+1-GB is enabled for scanning operation, the common voltage block row formed by the common voltage blocks CB21-CB2M is set to the first common voltage block row. The switch SW12 coupled between the common voltage blocks CB21-CB2M and the first channel CH1 is turned on, and the switch SW22 coupled between the common voltage blocks CB21-CB2M and the second channel CH2 is cut off. The common voltage generating buffer BUF1 can provide a common voltage to the common voltage blocks CB21-CB2M through the first channel CH1 and the turned-on switch SW12.

It can be seen, the on-off statuses of the switches SW11-SW19 and the switches SW21-SW29 can be dynamic adjusted according to the display scanning operation. That is, control signals for controlling the switches SW11-SW19 and the switches SW21-SW29 can be generated according to the gate line signals of the in-cell touch and display apparatus 300. The control signals can be generated by a logic circuit by operating logic operation on the gate line signals of the in-cell touch and display apparatus 300, and a hardware structure of the logic circuit can be implemented by a person skilled in the art.

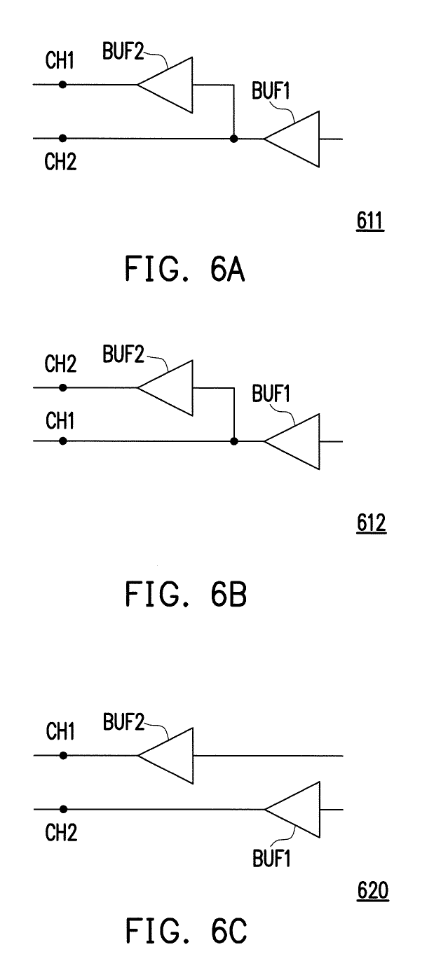

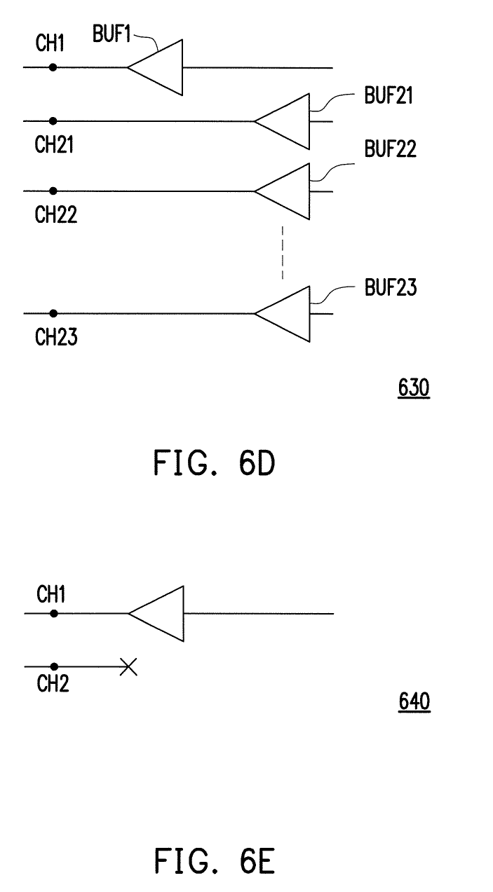

Referring to FIG. 6A to FIG. 6E, which respectively illustrate schematic plots of a plurality of voltage generator according to an embodiment of present disclosure. In FIG. 6A, the voltage generator 611 includes common voltage generating buffers BUF1 and BUF2. An output end of the common voltage generating buffer BUF1 is coupled to the second channel CH2 and an input end of the common voltage generating buffer BUF2. An output end of the common voltage generating buffer BUF2 is coupled to the first channel CH1. The common voltage generating buffer BUF2 is used to provide a common voltage to the first common voltage blocks and the common voltage generating buffers BUF1 is used to provide another common voltage to the second common voltage blocks.

In FIG. 6B, the voltage generator 612 includes common voltage generating buffers BUF1 and BUF2. An output end of the common voltage generating buffer BUF1 is coupled to the first channel CH1 and an input end of the common voltage generating buffer BUF2. An output end of the common voltage generating buffer BUF2 is coupled to the second channel CH2. The common voltage generating buffer BUF1 is used to provide a common voltage to the first common voltage blocks and the common voltage generating buffers BUF2 is used to provide another common voltage to the second common voltage blocks.

In FIG. 6C, the voltage generator 620 includes common voltage generating buffers BUF1 and BUF2. The common voltage generating buffers BUF1 and BUF2 are not connected to each other. The common voltage generating buffers BUF2 is coupled to the first channel CH1 for providing a common voltage to the first common voltage blocks, and the common voltage generating buffers BUF1 is coupled to the second channel CH2 for providing another common voltage to the second common voltage blocks.

In FIG. 6D, the voltage generator 630 includes common voltage generating buffers BUF1 and BUF21-BUF23. The common voltage generating buffers BUF1 is coupled to the first channel BUF1 for providing a common voltage to the first common voltage blocks, and the common voltage generating buffers BUF21-BUF23 are respectively coupled to a plurality of second channels CH21-CH23 for providing a plurality of common voltages to the second common voltage blocks.

In FIG. 6E, the voltage generator 640 merely includes a common voltage generating buffers BUF1. The common voltage generating buffers BUF1 is coupled to the first channel CH1, and provides a common voltage to the first common voltage blocks. Furthermore, the second channel CH2 is floated, and the voltage generator 640 set common voltages of the second common voltage blocks to be high impedance.

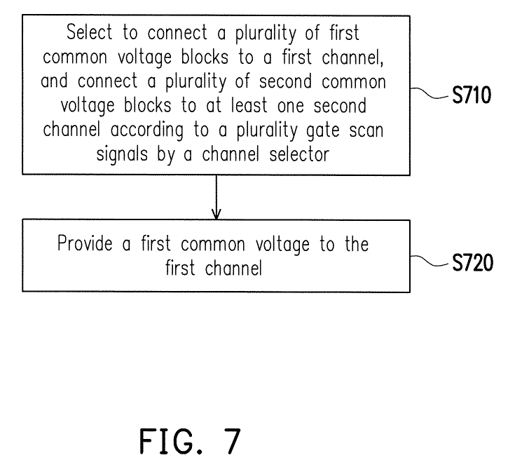

Referring to FIG. 7, which illustrates a flow chart of a common voltage providing method according to an embodiment of present disclosure. In FIG. 7, the a step S710 is executed for selecting to connect a plurality of first common voltage blocks to a first channel, and connect a plurality of second common voltage blocks to at least one second channel according to a plurality gate line signals by a channel selector. A step S720 is executing for providing a first common voltage to the first channel. Detail operations of the steps S710 and S720 have been described in above embodiments, and no more repeated descriptions here.

To conclusion, the invention sets a channel for providing a common voltage to the first common voltage blocks. Recovery time on the voltage level of the common voltages received by the first common voltage blocks can be minimized, and the display performance can be maintained.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A common voltage provider, adapted for an in-cell touch and display panel, comprising:
a channel selector, coupled to the in-cell touch and display panel, for selecting to connect a plurality of first common voltage blocks to a first channel, and connect a plurality of second common voltage blocks to at least one second channel according to a plurality gate line signals, wherein the first common voltage blocks are upon a scanned gate line and the second common voltage blocks are upon a plurality of non-scanned gate lines, and the gate line signals are respectively received by the scanned gate line and the non-scanned gate lines; and
a voltage generator, coupled to the first channel and the at least one second channel, and providing a first common voltage to the first channel.

2. The common voltage provider according to claim 1, wherein a capacitance on the first common voltage blocks is smaller than a capacitance on the second common voltage blocks.

3. The common voltage provider according to claim 1, wherein the channel selector comprises:
a plurality of first switches, respectively coupled to a plurality of common voltage block rows and coupled to the first channel commonly, wherein each of the first switches is turned on or cut off by determining whether the corresponding common voltage block row is upon the scanned gate line or not; and
a plurality of second switches, respectively coupled to the common voltage block rows and coupled to the second channel commonly, wherein each of the second switches is turned on or cut off by determining whether the corresponding common voltage block row is upon the scanned gate line or not.

4. The common voltage provider according to claim 3, wherein each of the first switches is turned on if the corresponding common voltage block row is upon the scanned gate line, and each of the second switches is cut off if the corresponding common voltage block row is not upon the scanned gate line; and
each of the first switches is cut off if the corresponding common voltage block row is not upon the scanned gate line, and each of the second switches is turned on if the corresponding common voltage block row is upon the scanned gate line.

5. The common voltage provider according to claim 3, wherein the common voltage block rows are respectively upon a plurality of gate line signal groups.

6. The common voltage provider according to claim 1, wherein the voltage generator comprises:
a common voltage generating buffer, an output end of the common voltage generating buffer is coupled to the first channel by a first wire, and the output end of the common voltage generating buffer is coupled to the at least one second channel by a second wire, and an input end of the common voltage generating buffer receives an input voltage.

7. The common voltage provider according to claim 1, wherein the voltage generator comprises:
a first common voltage generating buffer, coupled to the first channel and provides the first common voltage to the first channel; and
at least one second common voltage generating buffer, coupled to the at least one second channel and provides a second common voltage to the at least one first channel.

8. The common voltage provider according to claim 1, wherein the voltage generator is coupled to the first channel and provides the first common voltage to the first channel, and is coupled to the second channel and sets the at least one second channel being floated.

9. The common voltage provider according to claim 1, wherein the channel selector is controlled by a switching signal, and the switching signal is generated according to a plurality of gate line signals.

10. An in-cell touch and display apparatus, comprising:
a panel, having a plurality common voltage blocks arranged in an array;
a common voltage provider as claimed in claim 1, coupled to the panel.

11. A common voltage providing method, comprising:
selecting to connect a plurality of first common voltage blocks to a first channel, and connect a plurality of second common voltage blocks to at least one second channel according to a plurality gate line signals by a channel selector, wherein the first common voltage blocks are upon a scanned gate line and the second common voltage blocks are upon a plurality of non-scanned gate lines, and the gate line signals are respectively received by the scanned gate line and the non-scanned gate lines; and
providing a first common voltage to the first channel.

12. The common voltage providing method according to claim 11, wherein a capacitance on the first common voltage blocks is smaller than a capacitance on the second common voltage blocks.

13. The common voltage providing method according to claim 11, further comprising:
providing a second common voltage to the second channel.

14. The common voltage providing method according to claim 11, further comprising:
setting the second channel to be floated.
